(19) United States
(12) Patent Application Publication
(10) Pub. No.: US 2004/0177515 A1
(43) Pub. Date: Sep. 16, 2004

(54) Manual food cutting device and method of using same

(76) Inventor: Mark Horton, Burlington, VT (US)

Correspondence Address: John F. Klos, Esq., Fulbright & Jaworski L.L.P., Suite 2100, 80 South Eighth Street, Minneapolis, MN, 55402-2112, US

(21) Appl. No.: 10/762,642

(22) Filed: Jan. 20, 2004

Related U.S. Application Data
(60) Provisional application No. 60/454,949, filed on Mar. 12, 2003.

(51) Int. Cl. B26B 3/00

(52) U.S. Cl. 30/319

(57) ABSTRACT

A cutting device for food products having a handle, a neck portion, and a circular cutting blade. The handle is generally curved relative to its longitudinal axis and includes a top surface with a finger stop, the finger stop engaging a user's index finger during use. The handle length is sized in proportion to a typical user's hand so that a free end of the handle is proximate the user's palm. During use, the user's index finger engages a finger stop and a top surface of the handle. A method of using such a flat food item cutting device is also disclosed.

### RELATED APPLICATIONS

This application claims the benefit of priority, pursuant to 35 U.S.C. § 119, of U.S. Provisional Patent Application Serial No. 60/454,949, filed Mar. 12, 2003, hereby incorporated by reference herein in its entirety.

### BACKGROUND

Utensils for cutting pizza into slices for human consumption are known in the prior art.

Specialized tools to cut pizza are also known. Such pizza cutters typically include a circular blade attached to a handle. The handle is generally relatively substantial in comparison to the size of a knife or fork handle. The cutting blade is attached to the handle and, in operation, rotates relative to the handle in a plane perpendicular to the surface of the pizza. The circular blade thus forms a cutting wheel which allows the user to cut the pizza by rolling the cutting wheel across the pizza while applying downward pressure. Typically, a user grasps the pizza cutter in a clenching manner, with the user's fingers encircling the handle, e.g. similar to gripping a bicycle handle bar. The known pizza cutters are generally used to cut the pizza into large triangular pieces. Individual knifes and forks are subsequently used to further cut the pizza into bite-sized pieces. Use of known rotary pizza cutters requires a level of manual dexterity that some users may not possess. For example, children or elderly may have difficulty manipulating the cutter in such a manner to cut pizza.

Prior art pizza cutters and relevant other cutters are disclosed in U.S. Pat. Nos. D0448611; D0393987, RE032501, D0232413, 4,809,437, 0,388,305, D0346542, 5,428,898, D0341764, 5,144,749, D0350462, D0222380, D0461380, D0433912, 5,555,625, 5,737,803 and 6,044,565, each patent being incorporated by reference herein for all that it teaches and discloses.

### SUMMARY OF PRESENT INVENTION

The present invention relates to a manual cutting device of the type having a disc-like circular blade rotatably mounted to a handle which is useful for cutting pizza or other relatively thin planar food stuffs.

The present invention is directed to a novel manually operated cutting device which includes a circular blade rotatably mounted on a handle. The new food cutter is designed to be grasped and used in a manner similar to a steak knife, with the index finger on the top of the handle and the other fingers wrapped around the handle. The new food cutter may be used in place of a knife and allows the user to cut food into bite-sized pieces. A novel method of use of the device is also disclosed.

### BRIEF DESCRIPTION OF THE DRAWINGS

FIG. 1 is a left side perspective view of a cutting device for pizza and similar food products constructed in accordance with the present invention.

FIG. 1a is a sectional view of the cutting device of FIG. 1 taken along lines a—a.

FIG. 2 is a right side perspective view of the cutting device shown in FIG. 1.

FIG. 3 is an illustration of the cutting device of FIGS. 1 and 2 as being grasped by a user.

### DETAILED DESCRIPTION

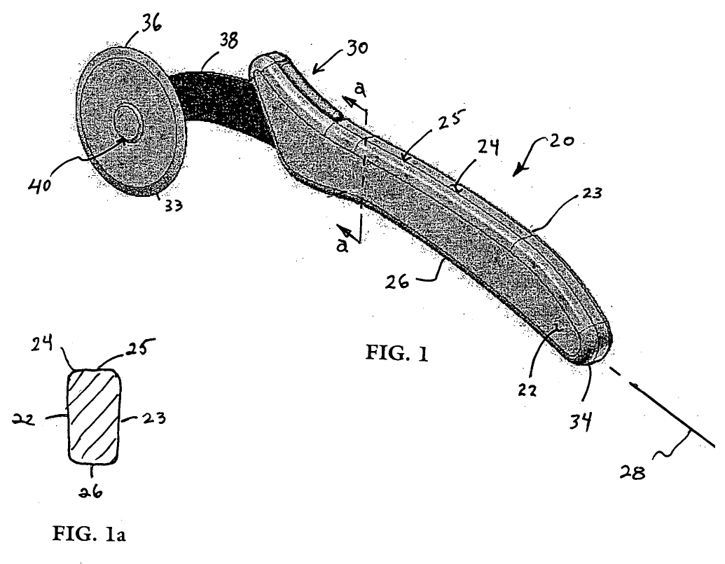

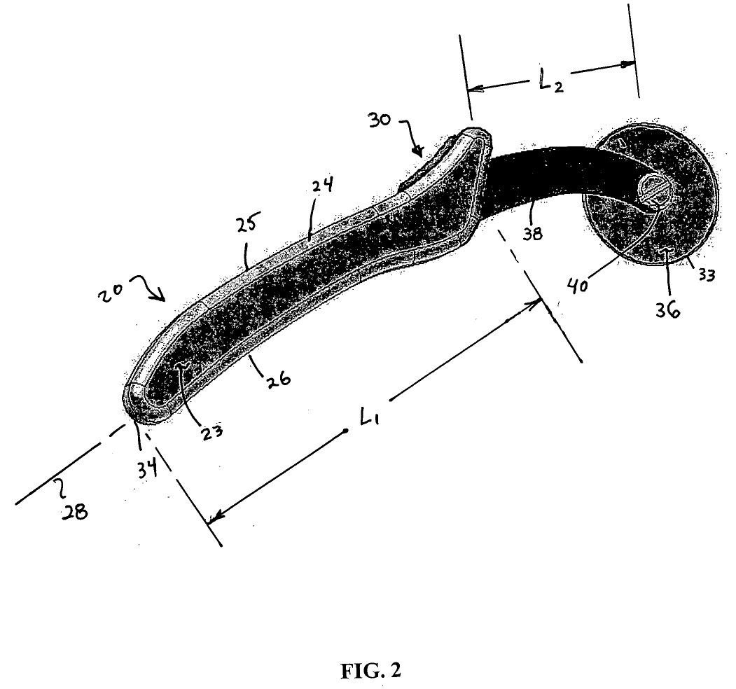

A cutting device for food products and the like, constructed in accordance with the present invention, is shown in FIGS. 1, 2 and 3 and includes a handle portion, indicated generally at 20, which facilitates manual manipulation of the device.

Handle 20 includes two generally flat outer side faces 22, 23, a top surface 24, and a bottom surface 26. Handle 20 may be manufactured of a variety of materials as appreciated by one of ordinary skill in the art. For example, handle 20 may be plastic, wood, metal, etc. In one preferred embodiment, handle 20 is approximately 6 inches long and % inch wide (distance between side faces 22, 23). Handle 20 width in alternative embodiments may range from approximately 1/4 inch to 3/4 inch. The variation in the length of handle 20 is further discussed below. Top surface 24 is generally curved relative to a longitudinal axis 28 of handle 20. Side faces 22, 23 are generally parallel faces and may be flat or slightly concave or convex.

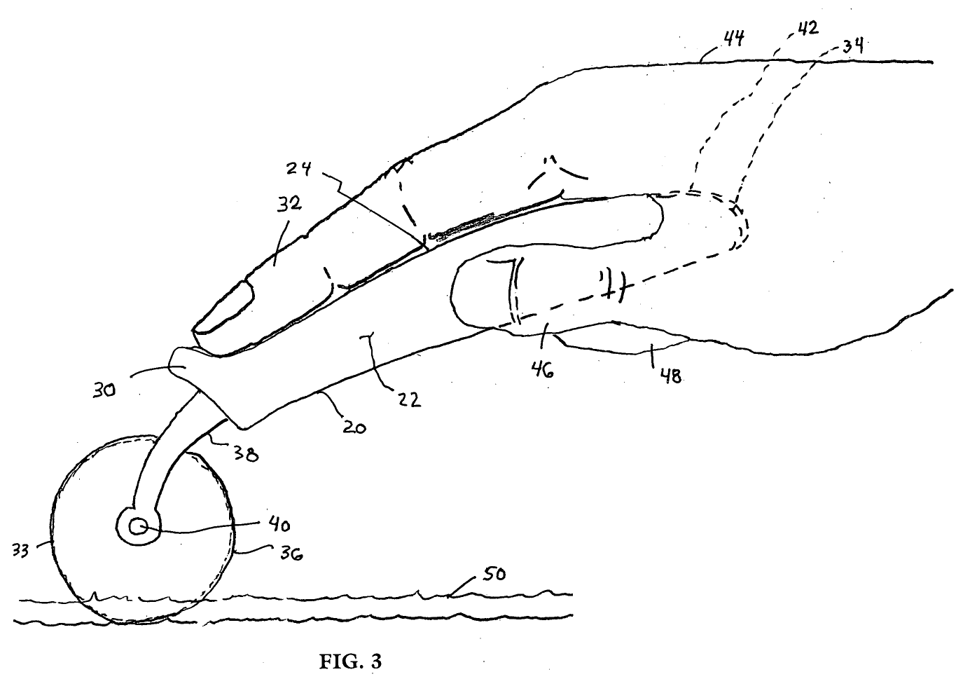

Top surface 24 of handle 20 defines a generally flat region 25 upon which a user's index finger 32 is engaged during use as indicated in FIG. 3. Flat region 25 promotes stability of the device during usage. The finger stop structure 30 promotes intuitive placement of the user's finger 32. The bottom surface 26 of handle 20 may further include one or more finger ridges (not shown) for engaging a user's finger during use. Finger stop structure 30 may include a configured surface, such as grooves, etc. (not shown) to minimize finger slippage relative to handle 20. Similarly, finger stop structure 30 may include an insert of different material, such as a rubber or silicone material, to minimize finger slippage. As illustrated in FIG. 3, top surface 24 is proportioned for receipt of an engaging surface of a human index finger 32. The handle 20 may also include an inclined top surface 24 which cooperates with the finger stop structure to reduce slipping of the fingers. Handle 20 may also include a finger guard (not shown).

As illustrated in FIG. 3, handle 20 is sized in proportion to a users hand 44. Preferably, handle 20 is sized so that its free end 34 is received within a user's palm 42 during use. As a result, the length, L1, of handle 20 is between approximately 4½ to 7 inches. More preferably, L1 of handle 20 is between approximately 5 to 6½ inches. Yet more preferably, L1 of handle 20 is approximately 6 inches.

In one embodiment, a disc-shaped, circular cutting blade/cutting wheel 36 is rotatably mounted to handle 20 via an elongated neck portion 38. The neck portion 38 is curved/arcuate and is at least twice the diameter of cutting wheel 36. Neck portion 38 has a length, L2, which is substantially greater than the diameter of cutting wheel 36. Preferably, the ratio between L2 and the diameter of cutting wheel 36 ranges from 2-4:1, that is, neck portion 38 has a length of between 2 to 4 times the diameter of cutting wheel 36. This enables the user to safely position his fingers further away from the blade and to provide greater leverage at the tip of the blade. Blade 36 includes a sharp outer edge 33 forming a cutting surface. Blade 36 is rotatably secured to neck 38 through an axle 40. Blade 36 has a diameter between approximately 1 1/2 and 2 inches. In one preferred embodiment, blade 36 has a diameter of approximately 2 inches. Neck 38 is secured to handle 20 and extends about 2 to 3 inches from the handle. The diameter of the blade 36 to the combined length of the handle 20 and neck 38 (L1+L2) is about 1 to 3. This enables the present invention to utilize a generally smaller diameter blade 36 while maintaining sufficient cutting force during usage.

In a preferred method of use, as illustrated in FIG. 3, free end 34 of handle 20 engages the palm 42 of a user's hand 44. The user's thumb 46 engages side surface 22, while other fingers 48 engage opposite side surface 23. Index finger 32 engages top surface 24 and finger stop 30. As can be appreciated, the overall geometry of handle 22 is sized to be held within the palm 42 of a typical user's hand 44. Pizza or other flat food item 50 is cut by rolling wheel 36 across the pizza or food item 50.

As applicable to pizza or the like, a cutter according to the present invention is particularly useful when a product has a harder, crisper crust or is unusually thick and conveniently aids a user having lesser strength or dexterity, such as a child, women or elderly persons.

It should be also noted that the construction of the present invention lends itself to manufacture employing molded plastic parts which are easily assembled to provide an inexpensive, but durable cutting device having the aforementioned advantages.

The invention of this application is described above both generically and with regard to specific embodiments. A wide variety of alternatives known to those of ordinary skill in the art can be selected within the generic disclosure. The examples provided herein are not to be limited by the examples, but rather, the claims are considered to provide the complete scope of the invention.

What is claimed is:

1. A cutting device comprising:
a cutting wheel;
a handle having a finger stop structure; and
a neck portion coupled to the cutting wheel and handle, and wherein the neck portion has a length greater than or equal to the diameter of the cutting wheel.

2. The cutting device of claim 1 wherein the finger stop structure is made of rubber.

3. The cutting device of claim 2 wherein the finger stop structure is an elongated pad extending along a top surface of the handle.

4. The cutting device of claim 1 wherein the ratio of the handle to a diameter of the cutting wheel is approximately 3 to 1.

5. The cutting device of claim 1 wherein the neck portion has an arcuate shape.

6. The cutting device of claim 1 wherein a length of the handle is between 4.5 to 7 inches.

7. The cutting device of claim 6 wherein the length is between approximately 5 to 6.5 inches.

8. The cutting device of claim 6 wherein the length is approximately 6 inches.

9. The cutting device of claim 1 wherein the cutting wheel is approximately 2 to 3 inches in diameter.

10. The cutting device of claim 1 wherein the handle is formed of one of the group consisting of plastic, wood, and metal.

11. The cutting device of claim 1 further comprising one or more finger ridges positioned on the handle.

12. A cutting device comprising:
a cutting wheel;
a handle made of a first material and having a top surface along a first end;
a finger stop structure connected to the top surface along the first end, the finger stop structure made of a slip-resistant second material; and
an arcuate neck coupling the cutting wheel to the first end of the handle, wherein the length of the neck portion is greater than the diameter of the cutting wheel.

13. The cutting device of claim 12 wherein the finger stop structure includes an elongated pad made of a slip-resistant material.

14. The cutter of claim 12 wherein the cutting wheel is approximately 2 to 3 inches in diameter.

15. The cutting device of claim 12 wherein the ratio of the combined length of the neck and the handle to the diameter of the cutting wheel is approximately 3 to 1.

16. The cutting device of claim 15 wherein the diameter of the cutting wheel is approximately 2 to 3 inches.

17. A method of eating a flat food item comprising the steps of:
providing a cutting device having a cutting wheel and a handle, said handle having a length of between 4.5 and 7 inches, and said handle having a finger stop;
grasping the handle of the cutting device, one end of the cutting device being held entirely within the palm of the user's hand, and one surface of the handle engaging a substantial portion of the user's index finger, and a tip of the index finger engaging the finger stop; and
rolling the cutting wheel across the flat food item to cut the food item.
